(19) United States
(12) Patent Application Publication
(10) Pub. No.: US 2024/0068570 A1
(43) Pub. Date: Feb. 29, 2024

(54) CORDLESS DUCTWORK SEALER WITH CUSTOM SPREADER HEADS KITS AND METHOD OF USING SAME

(71) Applicant: Donald Kenneth SOININEN, Algonquin Highlands (CA)

(72) Inventor: Donald Kenneth SOININEN, Algonquin Highlands (CA)

(21) Appl. No.: 17/822,165

(22) Filed: Aug. 25, 2022

(51) Int. Cl. F16J 15/14; F24F 13/02

(52) U.S. Cl. CPC F16J 15/14; F24F 13/0245

(57) ABSTRACT

The embodiments of the invention as described herein relate to a tool or device for sealing exterior duct joints. The device is designed and configured to drive a semi-solid mastic or cement-like material through a hose and a custom designed applicator wand. The various embodiments of the invention include cordless, lightweight and portable versions. This tool is designed to assist in the sealing of ductwork. An extension on the end of the wand enables a user to reach several areas that are either difficult to access, or awkward to seal using traditional techniques. Various embodiments of the spreader head have been designed to perform better for different parts of the duct system. The user only needs a ladder to seal the top of the supply trunk duct, the remainder of the ductwork can be sealed standing on the floor.

### FIELD OF THE INVENTION

The present invention relates generally to the field of devices for applying sealant to the outside of ductwork specifically to battery operated devices, more specifically to devices having custom designed sealant spreader heads, and a method of using the device.

### BACKGROUND

Sealing of ductwork is mandatory in all residential, commercial, and industrial installations. Various Provincial and State Building Codes stipulate that all joints of the ductwork shall be sealed to a Class A seal level in accordance with the HVAC Duct Construction Standards. Typical sealing methods involve installers using a type of rubberized cement or mastic to seal up the joints. The cement or mastic is usually applied with a brush, sealing any seams or joints where air could leak. The task is difficult and time consuming, requiring an installer to position and re-position ladders in order to access the areas to be sealed. The task is messy and somewhat wasteful, as the cement or mastic tends to drip from the applicator brush. Moreover, several seams and joints on ductwork are either difficult to access, or awkward to seal using a paint brush.

Various different techniques and devices are known, as described below. Any discussion of the related art throughout the specification should in no way be considered as an admission that such related art is widely known or forms part of common general knowledge in the field.

JP Patent No: 61293570 (Yasuhiro) discloses an automatic sealing apparatus for ducts for injecting a sealant injected by an air pump into an evacuated portion by an automatic flow gun, a regulator for regulating the pressure of an automatic flow gun is provided It is characterized by that. With such a configuration, a stable sealing agent can be injected and a sufficient sealing effect can be given to the fold-back portion.

U.S. Application No: 2007/0001030 (Duo Wang) discloses a method and apparatus for duct sealing using a clog-resistant insertable injector. The clog-resistant injector spray nozzle allows relatively unobtrusive insertion through a small access aperture into existing ductwork in occupied buildings for atomized particulate sealing of a ductwork. The spray nozzle comprises an easily cleaned and easily replaced straight liquid tube whose liquid contents are principally propelled by a heated propellant gas, such as heated air. Heat transfer is minimized from the heated propellant gas to the liquid tube until they both exit the injector, thereby greatly reducing the likelihood of nozzle clogging. A method of duct sealing using particles driven by heated propellant gas is described, whereby duct-sealing operations become both faster, and commercially practicable in inhabited commercial and residential buildings.

U.S. Application No: 2018/0339301 (Wolf) discloses Aerosolized air sealing of attic and ducting. The system also includes a source of liquid sealant and a source of air. The liquid sealant and the air are pumped through a hose to an aerosol sprayer. The aerosol sprayer atomizes the combination of the liquid sealant and the air to form aerosolized sealant particles.

U.S. Application No: 2015/0342336 (Martin) discloses a grout sealant dispensing wand assembly. grout sealant dispensing wand assembly is connected with a dispensing device through a hose in such a way that the wand assembly enables a user to apply grout sealant to a grout line without having to kneel down. The grout sealant is stored within the dispensing device and discharges through the hose to the wand assembly so that a head attachment of the wand assembly allows the user to evenly apply grout sealant. The head attachment is respectively connected with a flow control valve, a lever-controlled valve, and a handle of the wand assembly as the lever-controlled valve actuates the wand assembly and the flow control valve regulates the flow rate of the grout sealant.

U.S. Pat. No. 9,931,654 (West) discloses a portable fluid dispersal device. The device includes a system comprising a first chamber having pressurized gas, a compressor connected to the first chamber (which may be a bladder), and a second chamber connected to the first chamber. The second chamber includes contents. The system also includes an exit from the second chamber. The pressurized gas from the first chamber travels into the second chamber to force the contents out of the exit of the second chamber. The compressor increases the pressure of the gas in the first chamber.

U.S. Pat. No. 7,350,723 (Reedy) discloses a cordless, self-contained, handheld spray gun. The cordless, handheld spray gun comprises a fluid container in intercommunication with at least one fluid nozzle orifice and a source of pressurized gas in intercommunication with at least one gas nozzle orifice and one fan nozzle orifice. The spray gun is actuated by pulling a trigger that opens at least one valve so that the fluid, such as paint, primer, stain, varnish, sealant or the like, can flow to a fluid chamber, atomized, and sprayed through a fluid nozzle orifice out onto the article to be painted.

U.S. Pat. No. 4,096,973 (Checko) discloses a portable sealant applicator. Apparatus is provided for heating and extruding fluid sealant material onto a work surface which includes a heated feed chamber, a heated hose connected to the outlet of the feed chamber, and a handgun connected to the heated hose for applying the fluid sealant material onto the work surface. The feed chamber is provided with an opening for receiving sealant material is a solid bulk form and an outlet for dispensing sealant material in a fluid state.

U.S. Application No: 2017/0081864 (Bowe) discloses a light touch sealant applicator device. The present invention provides a device for applying a fluid sealant with a light touch, the device comprising a wand with a fluid sealant supply, either as part of the wand or as a separate supply tube, attached to the top of an applicator head via a universal joint, wherein the applicator head has a chamber on its underside which is sufficiently large to enable a constant supply of a fluid sealant to a substrate that is to be sealed, and the applicator head has a chamber edge disposed around its lower periphery adapted to strike the sealant flat. Methods of using the devices to form a seal, e.g. a weather-resistive barrier on a sheathed building structure, by applying a flexible and compressible foam to gaps in the structure are described. The foam may comprise one or more aqueous polymer having a glass transition temperature of less than 25° C.

U.S. Application No: 2020/0256583 (Yoskowitz) discloses a corner seal device for ductwork for conditioned air and method of assembly of such ductwork to prevent air leaks. A corner seal device is disclosed for use in preventing unwanted air leaks in ductwork sections intended for directing conditioned air in heating, ventilating and air conditioning systems (i.e., HVAC systems). The corner seal device eliminates potential air leaks caused inter alia, by the flange members of the ductwork sections, and further, it avoids previously known costly expenses and loss of time to seal the unwanted air leaks created when the flange members of the ductwork sections are made and are prepared for assembly of the ductwork sections. A method of assembly of such ductwork sections incorporating the unique corner seal device of the invention, is also disclosed. A duct for directing conditioned air in heating, ventilating and air conditioning systems incorporating such ducts is also disclosed. A heating, ventilating and air conditioning system incorporating such unique corner seal device and related structures is also disclosed.

U.S. Application No: 2009/0058078 (Knudson) discloses sealed ductwork. A sealed ductwork system has sealed, roll formed connections that form longitudinal seams and end joints for duct sections. The connections have one part with an open receptacle and a spaced flange, and another part with a round nose and a spaced tail. The nose fits into the receptacle with an interference fit and the flange secures the tail. Rectangular duct sections have radiused corners to facilitate sealing of the connections around the corners. A bead of sealant can be applied into the receptacle to enhance sealing.

U.S. Application No: 2019/0145651 (Gray) discloses A robotic system is provided for repeatedly and reproducibly applying a sealant to a seam in an assembled HVAC duct component. The applied sealant has a predetermined location on the assembled HVAC duct component to seal the seam. An assembled HVAC duct component is thus provided having a robot applied sealant on at least one seam in the assembled HVAC duct component, wherein the applied sealant has at least one of a predetermined location, thickness or coverage. The robotically applied sealant can be applied to a blank for forming the assembled HVAC duct component, wherein the sealant is located at locations forming a seam in the assembled HVAC duct component.

All documents cited herein are incorporated by reference.

None of the above cited documents, alone or in combination satisfy the need for a cordless, lightweight and portable device that provides better ductwork sealing, less waste, less time and enables a user to seal the base and sides of ductwork without using a ladder.

### BRIEF SUMMARY

It is an object of the invention to provide a cordless ductwork sealer with custom spreader heads, kits and method of using same.

In accordance with an aspect of the invention there is provided a device for sealing joints on ducting, said device comprising: a cylindrical dispensing system having a first end for dispensing sealant; a flexible applicator tube operatively attached at one end to said first end of said cylindrical dispensing system; a rigid applicator pipe attached at a controller end to an other end of said applicator tube; a spreader head attached to a dispensing end of said rigid applicator pipe; an actuator operatively connected to a second end of said dispensing system; a plunger having a circular cross section, attached to said actuator, said plunger sized and configured to fit within said cylindrical dispensing system; a control handle and trigger assembly connected to said controller end of said rigid applicator pipe; and a circuit comprising a battery operatively associated with a motor, configured to drive said actuator along said cylindrical dispensing system, wherein, when said trigger is activated, said battery drives said actuator to travel along said cylindrical dispensing system, propelling said sealant out through said first end of said cylindrical dispensing system, along the flexible applicator tube, and said rigid applicator pipe and out through said spreader head.

In accordance with another embodiment of the invention there is provided a method of sealing joints on ducting using the device of as described above, said method comprising: inserting sealant into said cylindrical dispensing system; selecting said spreader head having appropriately sized, shaped and spaced notches to correspond to joints on ducts to be sealed; attaching said selected spreader head on to said rigid applicator pipe; positioning said selected spreader head on joint to be sealed; depressing said trigger on said control handle and trigger assembly to activate said battery to drive said motor causing said plunger to propel said sealant along said applicator tube and applicator pipe and onto said spreader head; and guiding said selected spreader head along said joint to be sealed.

In accordance with yet a further embodiment of the invention there is provided a kit of parts to assemble the device as described above, the kit comprising: a cylindrical dispensing system, comprising a plunger; a flexible applicator tube configured to be attached to said cylindrical dispensing system; a rigid applicator pipe configured to be attached to an other end of said applicator tube; a spreader head configured to be attached to a dispensing end of said rigid applicator pipe; an actuator operatively connected to said dispensing system; a control handle and trigger configured to attach to said rigid applicator pipe; and a circuit connecting a battery terminal with a motor, configured to drive said actuator along said cylindrical dispensing system.

The advantages and features of the present invention will become better understood with reference to the following more detailed description and claims taken in conjunction with the accompanying drawings in which like elements are identified with like symbols.

To easily identify the discussion of any particular element or act, the most significant digit or digits in a reference number refer to the figure number in which that element is first introduced.

### BRIEF DESCRIPTION OF THE DRAWINGS

To easily identify the discussion of any particular element or act, the most significant digit or digits in a reference number refer to the figure number in which that element is first introduced.

FIG. 1 illustrates a side view of the cordless duct sealer in accordance with one embodiment of the invention.

FIG. 2 illustrates a perspective view of the cordless duct sealer in accordance with one embodiment of the invention.

FIG. 3 illustrates an exploded perspective view of the cordless duct sealer in accordance with one embodiment of the invention.

FIG. 4A illustrates a perspective view of a s-cleat and drive cleat spreader head matter in accordance with one embodiment of the invention.

FIG. 4B illustrates a top view of a s-cleat and drive cleat spreader head in accordance with one embodiment of the invention.

FIG. 5A illustrates a side view of a s-cleat and drive cleat spreader head matter in accordance with one embodiment of the invention.

FIG. 5B illustrates a perspective view of a s-cleat and drive cleat spreader head matter in accordance with one embodiment of the invention.

FIG. 6A illustrates a perspective view of a fish-lock collar and dovetail joint spreader head in accordance with one embodiment of the invention.

FIG. 6B illustrates a side view of a fish-lock collar and dovetail joint spreader head in accordance with one embodiment of the invention.

FIG. 7A illustrate top view of a fish-lock collar and dovetail joint spreader head in accordance with one embodiment of the invention.

FIG. 7B illustrates a perspective view of a fish-lock collar and dovetail joint spreader head in accordance with one embodiment of the invention.

FIG. 8A illustrates a perspective view of an elbow and pipe joint spreader head in accordance with one embodiment of the invention.

FIG. 8B illustrates a side view of an elbow and pipe joint spreader head in accordance with one embodiment of the invention.

FIG. 9A illustrates a top view of an elbow and pipe joint spreader head in accordance with one embodiment of the invention.

FIG. 9B illustrates a perspective view of an elbow and pipe joint spreader head in accordance with one embodiment of the invention.

FIG. 10A illustrates perspective view of an alternative s-cleat and drive cleat spreader head matter in accordance with one embodiment of the invention.

FIG. 10B illustrates perspective view of an alternative s-cleat and drive cleat spreader head matter in accordance with one embodiment of the invention.

FIG. 11 illustrates perspective view of an alternative fish-lock collar and dovetail joint spreader head matter in accordance with one embodiment of the invention.

FIG. 12 illustrates a HVAC duct having s-cleats and drive cleats

FIG. 13 illustrates a HVAC duct having fish-lock collars with dovetail joints.

FIG. 14 illustrates a HVAC duct having elbow joints.

FIG. 15A illustrates a perspective view of an alternative elbow and pipe joint spreader head in accordance with one embodiment of the invention.

FIG. 15B illustrates another perspective view of an alternative elbow and pipe joint spreader head in accordance with one embodiment of the invention.

FIG. 16A illustrates a cross-sectional side view of the cordless duct sealer in accordance with an alternative embodiment of the invention.

FIG. 16B illustrates another side view of the cordless duct sealer in accordance with an alternative embodiment of the invention.

### DETAILED DESCRIPTION

The embodiments of the invention as described herein relate to a tool or device for sealing exterior duct joints. The device is designed and configured to drive a semi-solid mastic or cement-like material through a hose and a custom designed applicator wand. The various embodiments of the invention include cordless, lightweight and portable versions. This tool is designed to assist in the sealing of ductwork. Typically, a small paint brush is used in combination with a tub of mastic or cement-like material to seal the duct joints. However, in many cases it is difficult to seal all of the seams and joints, and leaks remain.

With the various embodiment of the invention as described, more than half of the duct sealing can be done from the floor. An extension on the end of the wand enables a user to reach several areas that are either difficult to access, or awkward to seal using a paint brush. Various embodiments of the spreader head have been designed to perform better for different parts of the duct system. The user only needs a ladder to seal the top of the supply trunk duct, the remainder of the ductwork can be sealed standing on the floor. Hence use of the device results in less mess, better sealing, less waste and less time involved in the whole process.

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

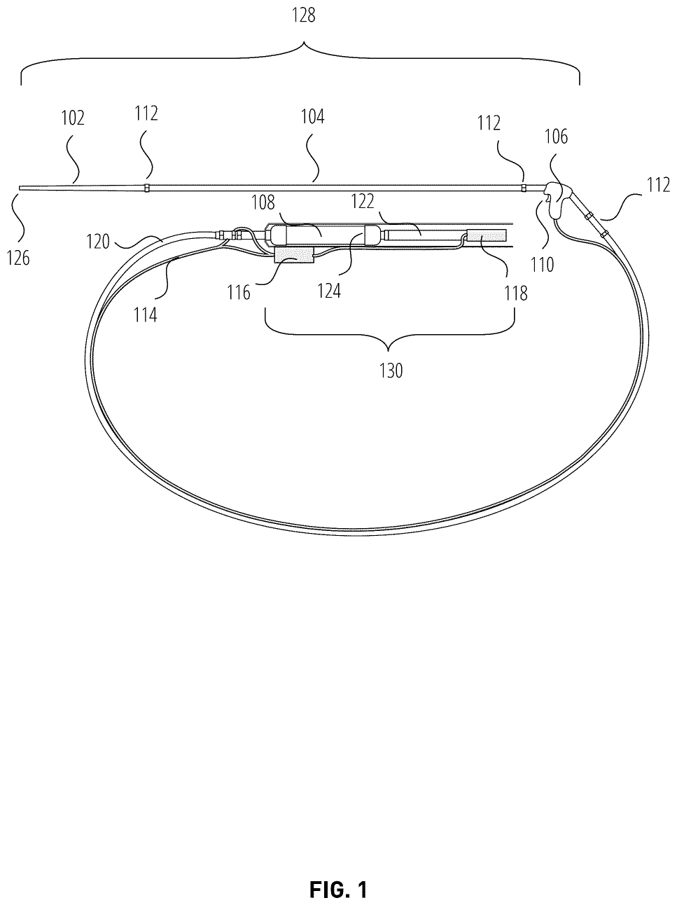

FIG. 1 illustrates a side view of an embodiment of the device. The device comprises an applicator wand 128 connected to a dispensing system or tool housing 130.

The applicator wand 128 comprises an applicator pipe 104 that is attached at one end to an extension pipe 102 and at the other end to a control handle 106. The extension pipe 102 may have a tip 126 for applying the sealant, or it may have a customized spreader head (not shown). The applicator pipe 104 and extension pipe 102 are connected to each other and to the control handle 106 via connectors 112.

The dispensing system or tool housing 130 comprises a canister of sealant 108 having a means of dispensing the sealant that typically consists of a diaphragm 124 connected to an actuator 122. A portable re-chargeable battery 116 is operatively connected to the actuator motor 118 which in turn drives the actuator 122/diaphragm 124 combination into the canister of sealant 108, thereby resulting in the sealant being dispensed from the canister.

The applicator wand 128 and dispensing system or tool housing 130 are connected by an activator wire 114 and a plastic tube 120. The activator wire 114 being operatively connected to a trigger 110 or activating mechanism located on the control handle 106. Activation of the trigger 110 or activating mechanism resulting in power being applied to the actuator 122 by the battery 116. The plastic tube 120 is attached at one end to the dispensing end of the canister of sealant 108 and at the other end to the applicator wand 128.

Activation of the trigger 110, or activating mechanism, resulting in the battery 116 driving the actuator 122 to force the diaphragm 124 into and through the canister of sealant 108. The sealant thereby being forced out through the dispensing end of the canister and along the plastic tube 120, into the applicator wand 128 and out through the tip 126, or custom head (not shown).

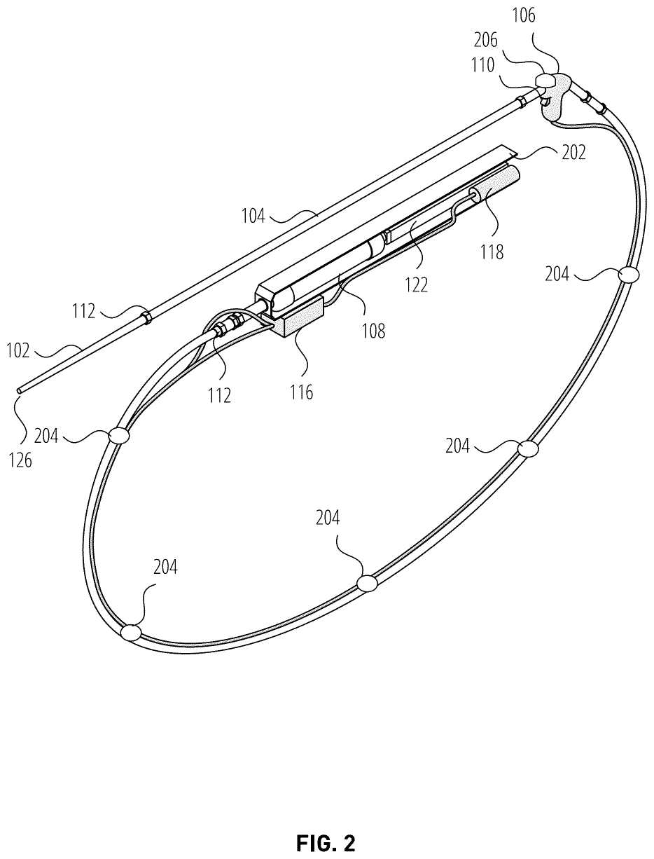

FIG. 2 illustrates a perspective view of an embodiment of the device. The device comprises an applicator wand 128 connected to a dispensing system or tool housing 130.

The various elements of the dispensing system or tool housing 130 can be seen enclosed in a dispensing system assembly member 202. The dispensing system assembly member 202 serves to provide structural integrity to, and protect, the elements of the dispensing system or tool housing 130. The dispensing system assembly member 202 may be totally enclosed, or partially enclosing the elements of the dispensing system or tool housing 130.

In this embodiment of the invention there is an LED light 206 situated on the control handle to provide illumination above the duct in the joint space. Also shown in this figure are a series of clips 204 to connect the activator wire 114 to the plastic tube 120. In other embodiments of the invention, the activator wire 114 may be wrapped around the plastic tube 120, thereby negating the need for the clips 204.

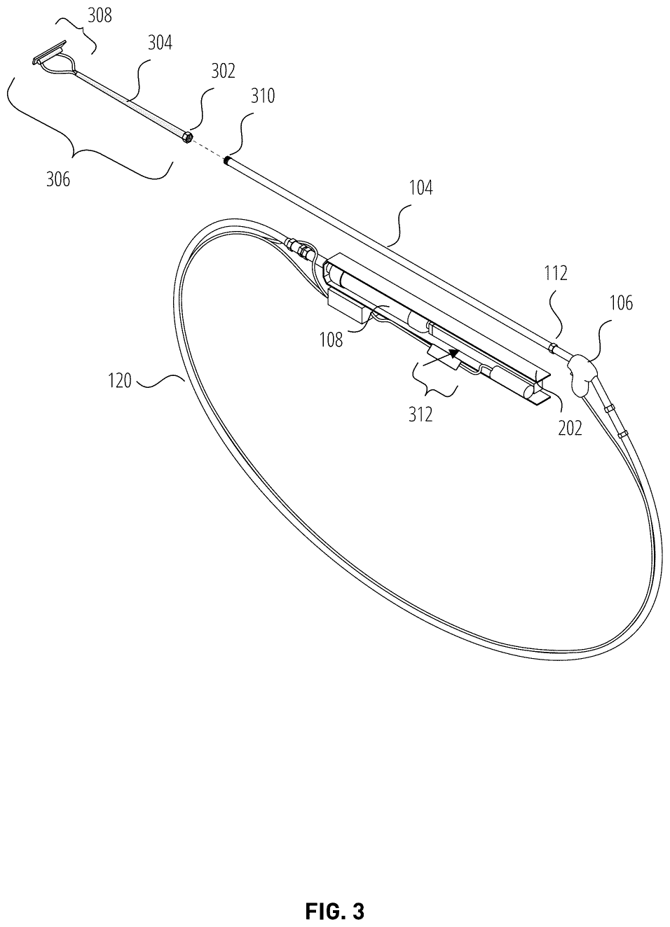

FIG. 3 illustrates the device as shown in FIG. 1 and FIG. 2, having a partially exploded view of the end section of the applicator extension head 306.

In this embodiment of the invention, a customized applicator extension head 306 can be seen. The applicator extension head 306 comprises a spreader head 308 attached to a custom extension pipe 304. The custom extension pipe 304 has a threaded connector 302 that is configured to attach to a co-operating threaded connector 310 on the distal, or dispensing, end of the applicator pipe 104.

In most embodiments of the invention, the connectors 112 comprise a pair of male and female co-operating threaded connectors 310. These co-operating threaded connectors 310 can be used to connect: the canister of sealant 108 to the plastic tube 120; the plastic tube 120 to the control handle 106; the control handle 106 to the applicator pipe 104; and the applicator pipe 104 to the custom extension pipe 304.

Various different embodiments of the invention may include a voltage regulating rheostat 312 that reduces the power that is supplied to the actuator motor 118 by the battery 116.

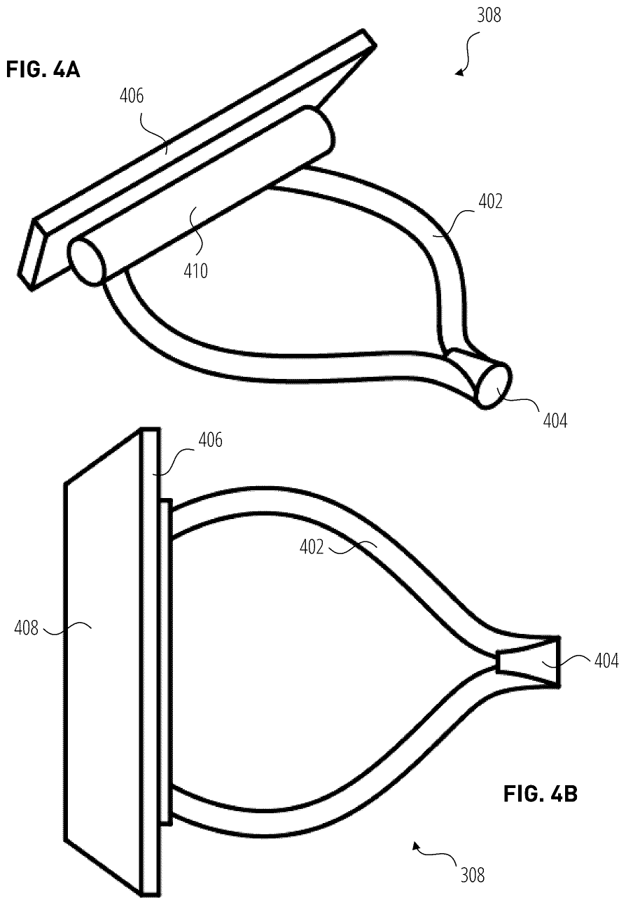

FIG. 4A illustrate a perspective view of an embodiment of a custom spreader head 308.

In this particular embodiment, the sealant is driven into the attachment point 404 and along a split applicator pipe 402. The sealant exudes from the ends (not shown) of the split applicator pipe 402 and is then spread along the seams and joints on the ductwork by the combination of the planar spreader 406 and the attachment rod 410. The attachment rod 410 in multifunctional, in that it aids in the spreading of the sealant, but it also adds structural stability and strength to the point of connection between the split applicator pipe 402 and the planar spreader 406.

FIG. 4B illustrate a top view of an embodiment of a custom spreader head 308.

As described above, the sealant is driven into the attachment point 404 and along a split applicator pipe 402. The sealant exudes from the ends (not shown) of the split applicator pipe 402 and is then spread along the seams and joints on the ductwork by the combination of the planar spreader 406 and the attachment rod 410.

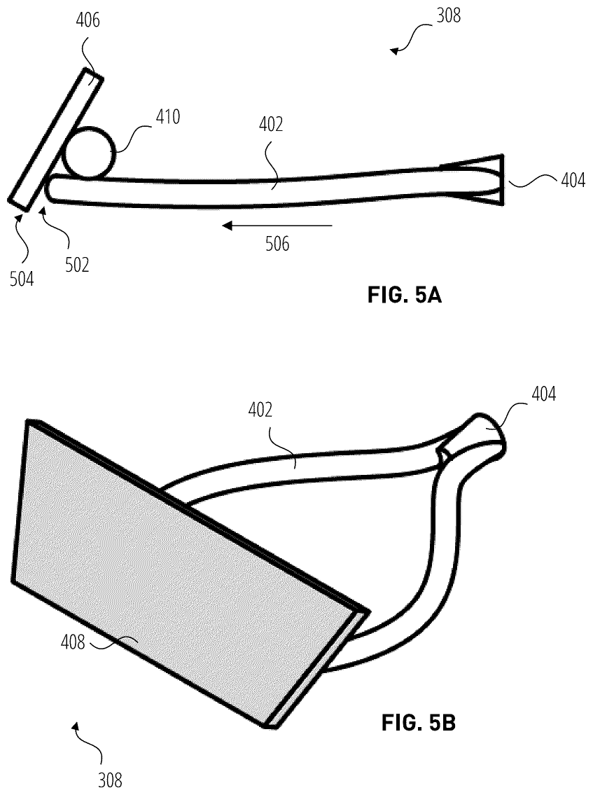

FIG. 5A illustrates a side view of the spreader head 308 illustrated in FIG. 4A and FIG. 4B.

FIG. 5A indicates the direction of flow 506 of the sealant from the attachment point 404 along the split applicator pipes 402. The sealant subsequently exudes out of the open end of pipe 502, where it can be spread by the spreader edge 504 of the planar spreader 406. As the sealant exudes out of the open ends of pipe 502, it extends into the space between the open ends of pipe 502 filling a gap between the open ends of pipe 502, the spreader edge 504 and the attachment rod 410. This results in a continuous reservoir of sealant being formed along the dispensing surfaces of the spreader head 308.

FIG. 5B illustrates a rear perspective view of the spreader head 308 illustrated in FIG. 4A, FIG. 4B, and FIG. 5A.

FIG. 5B shows the rear surface 408 of the planar spreader 406 and the attachment point 404 of the spreader head 308 to the applicator pipe 104 (not shown).

The custom spreader head 308 illustrated in FIG. 4A, FIG. 4B, FIG. 5A, and FIG. 5B is particularly suited for sealing S and drive cleats on HVAC ducting.

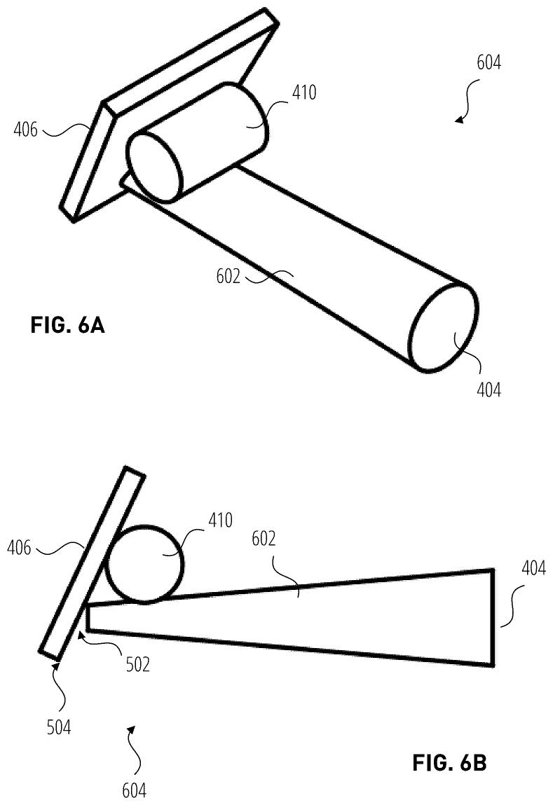

FIG. 6A illustrates a perspective view of an alternative spreader head 604 in accordance with another embodiment of the invention.

In this embodiment, a single applicator pipe 602 has an attachment point 404 at a first end and is connected to a planar spreader 406 at a second end via an attachment rod 410. In this embodiment of the invention, the attachment rod 410 functions to provide support to the connection between the applicator pipe 602 and the planar spreader 406.

FIG. 6B illustrates a side view of the alternative spreader head 604 in accordance with another embodiment of the invention.

As shown in FIG. 6B, the single applicator pipe 602 has an attachment point 404 at a first end and is connected to a planar spreader 406 at a second end via an attachment rod 410.

The sealant exuding from the open end of pipe 502 and the spreader edge 504 of the planar spreader 406 serving to spread the sealant to the seams and joints of the ductwork.

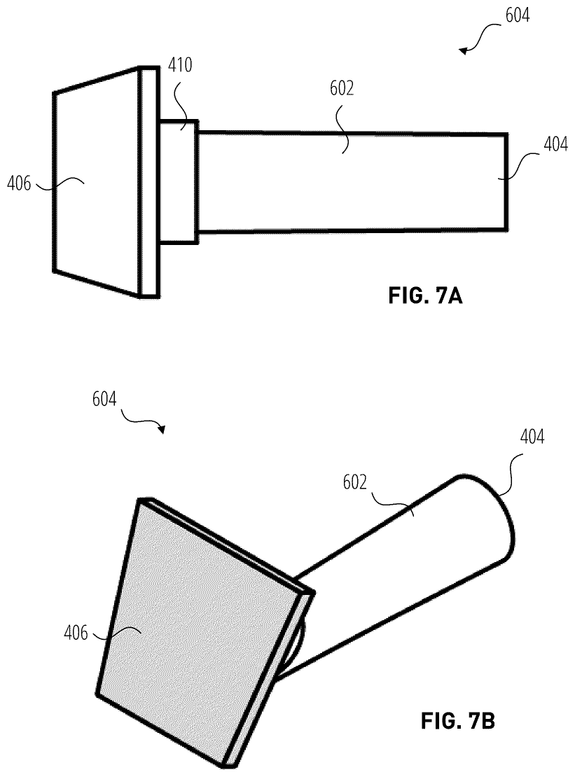

FIG. 7A illustrates a top view of the alternative spreader head 604 in accordance with another embodiment of the invention.

Again, the single applicator pipe 602 has an attachment point 404 at a first end and is connected to a planar spreader 406 at a second end via an attachment rod 410.

The size and dimensions of the planar spreader 406 in this embodiment of the invention are smaller than the embodiment illustrated in FIG. 4A, FIG. 4B, FIG. 5A, and FIG. 5B and are particularly well suited for applying sealant to ductwork in confined spaces.

FIG. 7B illustrates a rear perspective view of the alternative spreader head 604 in accordance with another embodiment of the invention.

As shown in FIG. 7A, the single applicator pipe 602 has an attachment point 404 at a first end and is connected to a planar spreader 406 at a second end via an attachment rod 410.

The custom spreader head 308 illustrated in FIGS. 6A, FIG. 6B, FIG. 7A and FIG. 7B is particularly suited for sealing fish-lock collar joints and dovetail joints on HVAC ductwork.

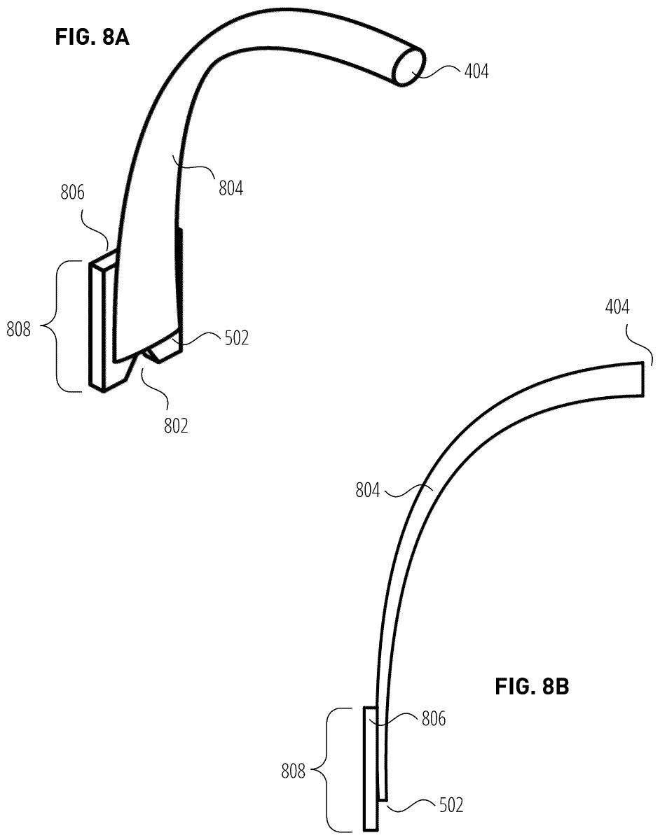

FIG. 8A illustrates a perspective view of a curved applicator pipe 804 and custom notched spreader head 808 in accordance with another embodiment of the invention.

In this embodiment, a single curved applicator pipe 804 is connected to a notched spreader head 808 having a planar surface 806 and a v-shaped notch 802 on one edge.

The sealant passes from the attachment point 404 along the curved applicator pipe 804 and exudes from the open end of pipe 502. The v-shaped notch 802 on the planar notched spreader 806 causing the sealant to be deposited in a long continuous bead along the desired position on the ductwork.

FIG. 8B illustrates a side view of the curved applicator pipe 804 and custom notched spreader head 808 in accordance with another embodiment of the invention.

Again, this figure shows a single curved applicator pipe 804 is connected to a notched spreader head 808 having a planar surface and a v-shaped notch 802 on one edge.

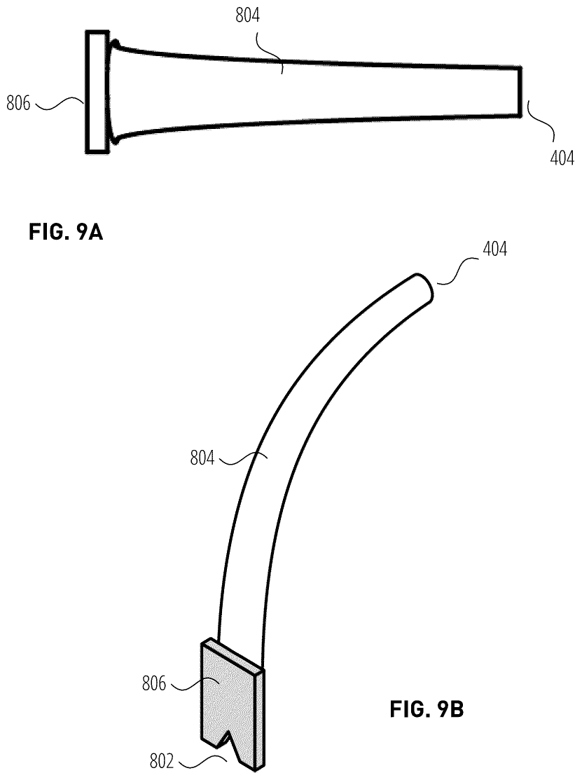

FIG. 9A illustrates a top view of the curved applicator pipe 804 in accordance with the other embodiment of the invention.

The single curved applicator pipe 804 having a first end adapted to connect with an applicator pipe 104 (not shown) is connected to a notched spreader head 808 having a planar surface at a second end.

FIG. 9B illustrates a rear perspective view of the curved applicator pipe 804 in accordance with the other embodiment of the invention.

The curved applicator pipe 804 and custom notched spreader head 808 illustrated in FIGS. 8A, FIG. 8B, FIG. 9A, and FIG. 9B is particularly suited for sealing elbows and pipe joints on HVAC ductwork.

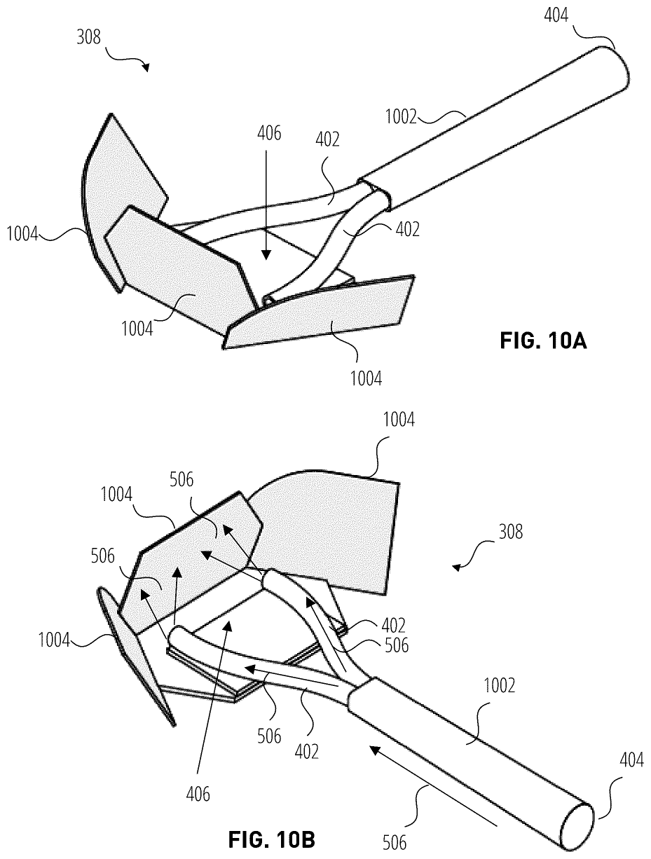

FIG. 10A illustrates a top perspective view of an embodiment of the invention.

The custom spreader head 308 illustrated in FIG. 10A is specifically designed for applying sealant to s-cleat and drive cleat joints on HVAC ductwork.

The spreader head 308 illustrated in FIG. 10A shows the split applicator pipe 402 and attachment point 404 separated by a spacer pipe 1002. The spreader head 308 closely resembles the embodiment illustrated and described in FIG. 4A, FIG. 4B, FIG. 5A, and FIG. 5B. However, in this particular embodiment, one or more flexible spreader blades 1004 are positioned around the outer edges of the planar spreader 406.

FIG. 10B illustrates an alternative top perspective view of an embodiment of the invention.

FIG. 10B shows the custom spreader head 308 illustrated in FIG. 10A that is specifically designed for applying sealant to s-cleat and drive cleat joints on HVAC ductwork.

FIG. 10B shows the direction of flow 506 of the sealant from the applicator pipe 104 (not shown) moving from the attachment point 404 along the split applicator pipe 402 and out onto the planar spreader 406. The flexible spreader blades 1004 situated on the edges of the planar spreader 406 help retain and guide the sealant onto the seams of the s—and drive cleats on the HVAC ductwork.

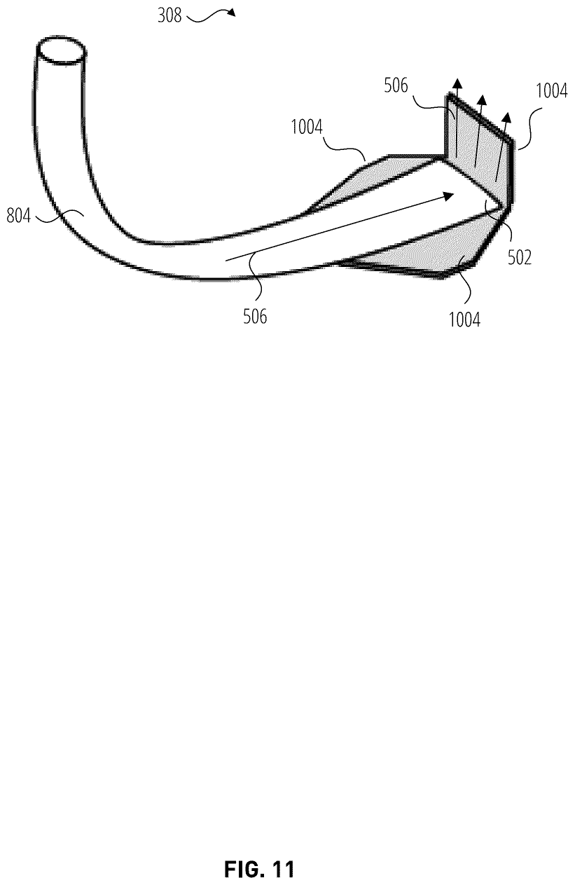

FIG. 11 illustrates a perspective view of yet another embodiment of the invention.

The particular spreader head 308 resembles the spreaders illustrated and described in FIGS. 6A, FIG. 6B, FIG. 7A and FIG. 7B is also particularly well suited for sealing fish-lock collar joints and dovetail joints on HVAC ductwork.

This particular embodiment has flexible spreader blades 1004 attached to the front and side edges of the either the curved applicator pipe 804 or the planar spreader which may be notched to form a planar notched spreader 806.

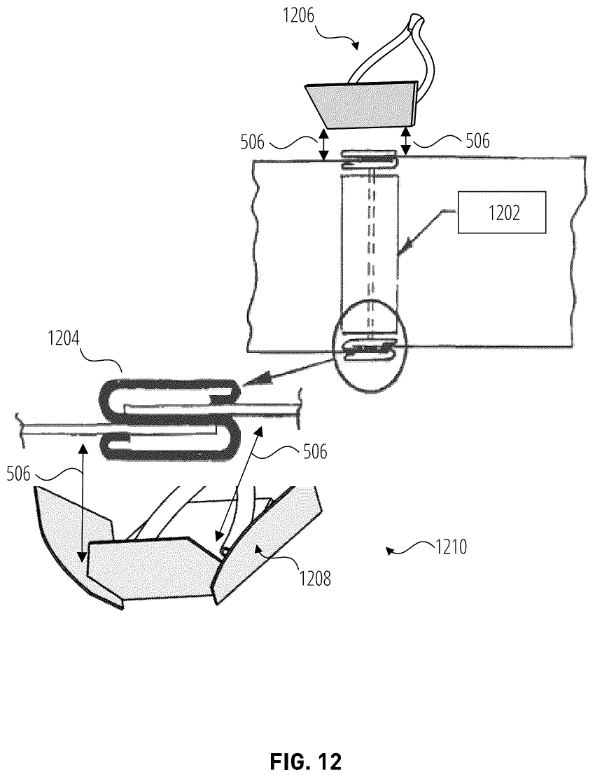

FIG. 12 shows a custom s and drive cleat spreader heads in spatial relation to an s-cleat 1204 and a drive cleat 1202 on a HVAC duct.

The specific design and placement of parts on the s- and drive cleat spreader head 1206 is sized and positioned such that the direction of flow 506 of the sealant seals both seams of s- and drive cleats.

The specific design and placement of parts on the bladed s- and drive cleat spreader head 1210 is sized and positioned such that the direction of flow 506 of the sealant seals both seams of s- and drive cleats. The flexible spreader blades 1004 aid in the precision application of sealant and reduce waste.

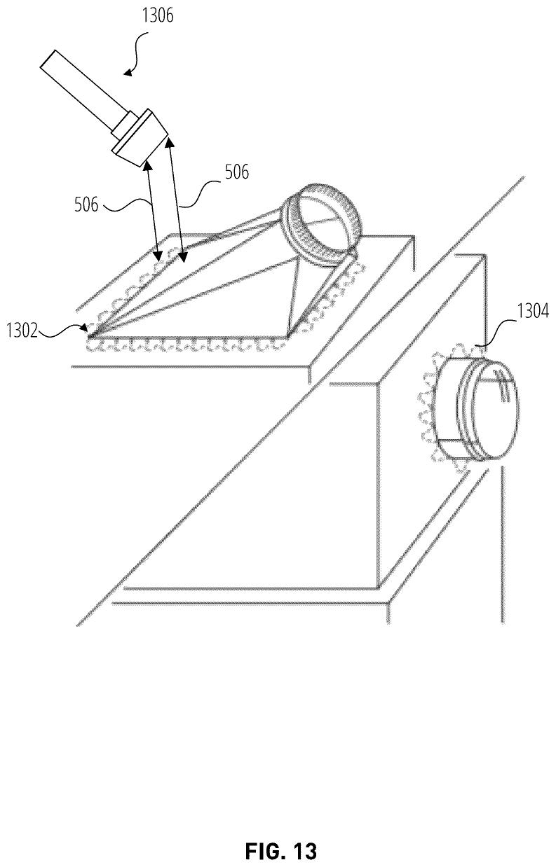

FIG. 13 shows a custom fish-lock collar and dovetail joint spreader head 1306 in spatial relation to a fish-lock collar 1302 and dovetail joints 1304 on a HVAC duct. The direction of flow 506 of sealant can be seen to seal the joints with minimal wastage of sealant.

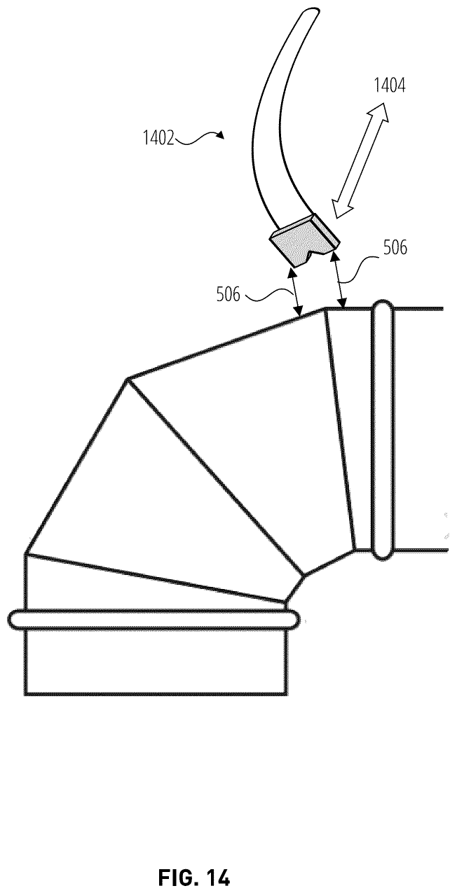

FIG. 14 shows a custom elbow and pipe joint spreader head 1402.

The elbow and pipe joint spreader head 1402 can be used to apply sealant or mastic to elbow and pipe joints on ducting including circular pipes.

The direction of motion of spreader head 1404 is indicated that results in the direction of flow 506 of sealant.

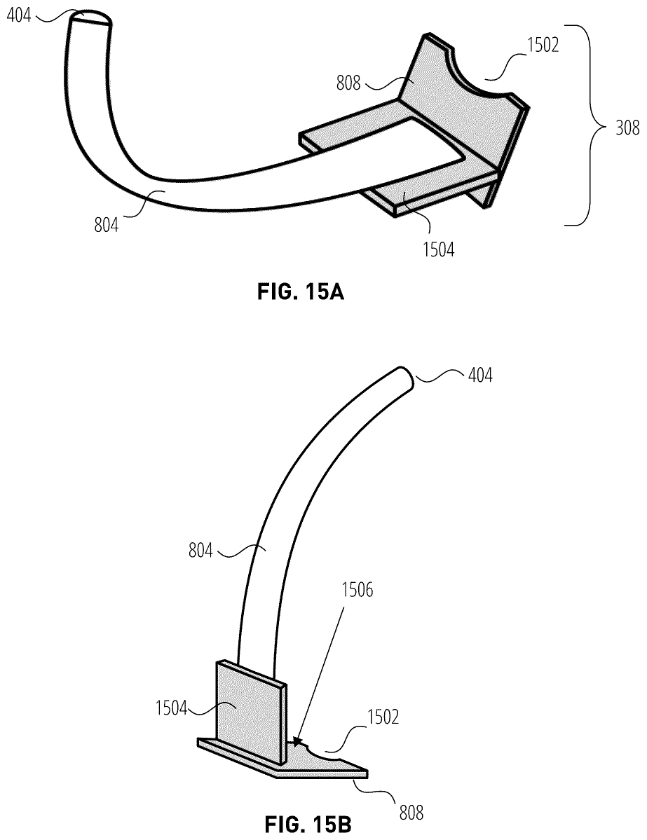

FIG. 15A shows a perspective view of a curved applicator pipe 804 and custom notched spreader head 808 having a curved notch 1502 in accordance with another embodiment of the invention.

In this embodiment, a single curved applicator pipe 804 is connected to a notched spreader head 808 having an attachment plate 1504 attached to a spreader head 308 having a curved notch 1502 one edge.

The sealant passes from the attachment point 404 along the curved applicator pipe 804 and exudes from the open end of pipe 502. The curved notch 1502 on the spreader head 308 causing the sealant to be deposited in a long continuous bead along the desired position on the ductwork.

This particular spreader head 308 is suitable for applying sealant, caulk or mastic to a pipe joint.

FIG. 15B shows another perspective view of a curved applicator pipe 804 and custom notched spreader head 808 having a curved notch 1502 in accordance with another embodiment of the invention.

In this embodiment, a single curved applicator pipe 804 is connected to a notched spreader head 808 having an attachment plate 1504 attached to a spreader head 308 having a curved notch 1502 one edge. The angle between the attachment plate 1504 and the notched spreader head 808 is an approximate right angle 1506.

The sealant passes from the attachment point 404 along the curved applicator pipe 804 and exudes from the open end of pipe 502. The sealant, caulk or mastic accumulates in the approximate right angle 1506 formed between the attachment plate 1504 and the notched spreader head 808. The curved notch 1502 on the spreader head 308 causing the sealant to be deposited in a long continuous bead along the desired position on the ductwork.

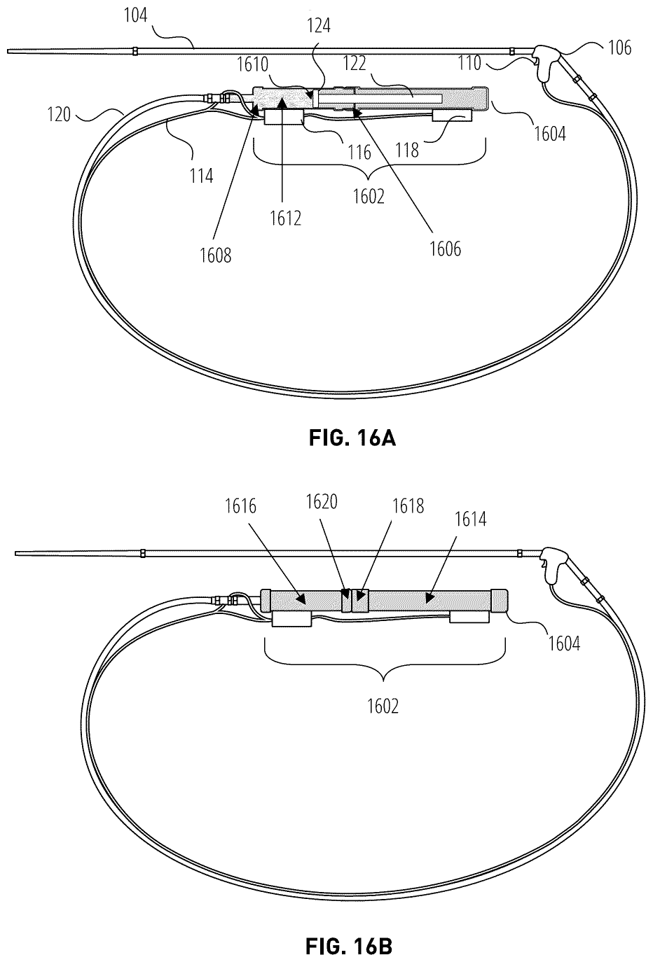

FIG. 16A shows cross-sectional view of an alternative dispensing system 1602 comprising a sending unit canister 1604 having contained within an actuator 122 terminating in a diaphragm 124.

The sending unit canister 1604 has a circular cross-section (not shown) and the plunger head 1610 of the diaphragm 124 is circular and sized and proportioned to contact the inner edges of the sending unit canister 1604. When the diaphragm 124 is in a first position 1606, mastic or sealant can be loaded into the enclosed canister void 1612. When the actuator motor 118, powered by the battery 116, drives the diaphragm 124 towards the second position 1608, the mastic or sealant is driven out of the sending unit canister 1604 via the plastic tube 120.

The other elements of the device, including the applicator pipe 104, control handle 106, trigger 110 and activator wire 114, are as shown in FIG. 1-FIG. 3.

FIG. 16B shows a side view of the alternative dispensing system 1602 comprising a sending unit canister 1604 having contained within an actuator 122 terminating in a diaphragm 124.

The fully enclosed nature of the sending unit canister 1604 can be seen in this figure. Typically the sending unit canister 1604 comprises two sections; a first end 1614 and a second end 1616. The first end 1614 has a first connector end 1618 and second end 1616 has a second connector end 1620. The first connector end 1618 and the second connector end 1620 are operatively associated together via connections known to those of skill in the field. For example, the first connector end 1618 and second connector end 1620 may be screw threaded or bayoneted fittings.

As described above, the embodiments of the invention as described herein relate to the application of a semi solid material, such as mastic, to seal exterior joints of ductwork using an applicator wand 128 and dispensing system or tool housing 130 connected via a plastic tube 120. Rectangular duct connections are made with S and drive cleats, and the duct joints should always be secured with #8 sheet-metal screws before seams are sealed with sealant or mastic. The device described is battery powered/cordless, portable and easy to use. There may be an LED light on the control handle to provide illumination above the duct in the joint space.

The applicator pipe 104, extension pipe 102, split applicator pipe 402, applicator pipe 602, and curved applicator pipe 804 are typically made from metal. Preferably a rigid, light metal such as aluminum. Steel may be used, including stainless steel. The inner surfaces of the applicator pipe 104, extension pipe 102, split applicator pipe 402, applicator pipe 602, and curved applicator pipe 804 may be coated with a non-stick coating, such as Teflon″, such that the sealant does not build up within the pipes and reduce the flow rate.

The elements of the various spreader heads 308, spreader rods 410, and spreader surfaces, such as planar notched spreader 806, v-shaped notch spreader 802, and curved notch spreader 1502, are typically made from a hard plastic. The plastic may be molded, extruded or 3D printed into the desired shape.

An example of 3D printable plastics includes polylactic acid, or PLA, this material has the benefit of being biodegradable as it is manufactured using renewable raw materials such as corn starch. ABS filament another type of 3D printing thermoplastic which contains a base of elastomers based on polybutadiene, making it more flexible, and resistant to shocks. ASA is a material that has similar properties to ABS, but has a greater resistance to UV rays. Polyethylene terephthalate, or PET, is ideal for fabricating larger more rigid frames. PETG, is a glycolyzed PET polymer that combines both the simplicity of PLA 3D printing and the strength of ABS, and it is 100% recyclable. Numerous other 3D printable polymers, hybrids and composites are known and considered to be within the scope of protection sought.

Plastics that are particularly suitable for injection molding include Nylon™ acrylics, which are particularly suitable for being tinted, polycarbonate (PC), polyoxymethylene (POM), polystyrene (PS), acrylonitrile butadiene styrene (ABS), polypropylene (PP), polyethylene (PE), thermoplastic polyurethane (TPU), and thermoplastic rubber (TPR).

Plastics that are particularly suitable for extrusion include polyethylene (PE), polypropylene, acetal, acrylic, nylon (polyamides), polystyrene, polyvinyl chloride (PVC), acrylonitrile butadiene styrene (ABS) and polycarbonate.

The various different parts of the spreader system can be sold in kit form. The kit may comprise the sending unit canister 1604, plastic tube 120, control handle 106, applicator wand 128, actuator motor 118, and optional battery 116. A kit of various spreader heads, including but not limited to a planar spreader 406, flat spreaders 806, v-shaped notch 802, curved notch 1502, may be sold separately or they may be included within the kit comprising the sending unit canister 1604, plastic tube 120, control handle 106, applicator wand 128, actuator motor 118, and optional battery 116.

The method of using the duct sealing tool is described below:
Step #1—Unscrewing the canister of sealant 108 or sending unit canister 1604 from the dispensing system or tool housing 130;
Step #2—Inserting canister of sealant 108 into dispensing system or tool housing 130. In some embodiments of the invention, this may be done by inserting a threaded male end of caulking tube into female receiving end of the dispensing system or tool housing 130. In alternative embodiments of the invention the enclosed canister void 1612 may be filled with sealant, caulk or mastic;
Step #3—Inserting plunger or actuator 122 from dispensing system or tool housing 130 into end of canister of sealant 108;
Step #4—Screwing the dispensing system or tool housing 130 back together;
Step #5—Selecting the appropriate spreader head 308, as determined by the duct joint to be sealed;
Step #6—Screwing the appropriate spreader head 308 on to the threaded end of the applicator pipe 104 or custom extension pipe 304.
Step #7—Inserting 12-volt battery 116 to power the plunger or actuator 122.
Step #8—Pressing trigger 110 on control handle 106 until a small amount of duct sealer, caulk or mastic, exudes out of the end of the spreader head 308.
Step #9—Adjusting the speed that the duct sealer, caulk or mastic, comes out of spreader head 308 by adjusting the voltage regulating rheostat 312.
Step #10—Pressing spreader head 308 onto surface area to be sealed.
Step #11—Pulling the spreader head 308, with a firm and smooth movement, along the seam to be sealed while pressing the trigger 110 on the control handle 106.

The term “connected”, “attached”, “affixed” or “coupled to” may include both direct coupling (in which two elements that are coupled to each other contact each other) and indirect coupling (in which at least one additional element is located between the two elements).

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A device for sealing joints on ducting, said device comprising:
a cylindrical dispensing system having a first end for dispensing sealant;
a flexible applicator tube operatively attached at one end to said first end of said cylindrical dispensing system;
a rigid applicator pipe attached at a controller end to an other end of said applicator tube;
a spreader head attached to a dispensing end of said rigid applicator pipe;
an actuator operatively connected to a second end of said dispensing system;
a plunger having a circular cross section, attached to said actuator, said plunger sized and configured to fit within said cylindrical dispensing system;
a control handle and trigger assembly connected to said controller end of said rigid applicator pipe; and
a circuit comprising a battery operatively associated with a motor, configured to drive said actuator along said cylindrical dispensing system,
wherein, when said trigger is activated, said battery drives said actuator to travel along said cylindrical dispensing system, propelling said sealant out through said first end of said cylindrical dispensing system, along the flexible applicator tube, and said rigid applicator pipe and out through said spreader head.

2. The device of claim 1, wherein said cylindrical dispensing system is sized to receive a pre-filled tube of sealant.

3. The device of claim 1, wherein said cylindrical dispensing system completely encloses a voided area that can be manually filled with sealant.

4. The device of claim 1, wherein said flexible applicator tube is threadedly connected at one end to said first end of said cylindrical dispensing system.

5. The device of claim 1, wherein said flexible applicator tube is threadedly connected at an other end to said rigid applicator pipe.

6. The device of claim 1, wherein said dispensing end of said rigid applicator pipe is threadedly connected to said spreader head.

7. The device of claim 5, wherein an extension pipe is threadedly inserted between said dispensing end of said applicator pipe and said spreader head.

8. The device of claim 1, wherein a rheostat is operatively connected between said battery and said motor.

9. The device of claim 1, wherein said spreader head has a v-shaped notch.

10. The device of claim 1, wherein said spreader head has a curved notch.

11. The device of claim 1, wherein said spreader head has two or more planar sections arranged in an abutting configuration, forming v-shaped notched between each of said two or more planar sections.

12. The device of claim 1, wherein said spreader head comprises a planar spreader surface that abuts said dispensing end of said application pipe, said planar spreader surface being attached to said dispensing end of said application pipe via an attachment rod.

13. The device of claim 1, wherein said dispensing end of said application pipe is a split applicator pipe and said a spreader head comprises a planar spreader surface that abuts said split application pipe, said planar spreader surface being attached to said split applicator pipe via an attachment rod.

14. A method of sealing joints on ducting using the device of claim 1, said method comprising:
inserting sealant into said cylindrical dispensing system;
selecting said spreader head having appropriately sized, shaped and spaced notches to correspond to joints on ducts to be sealed;
attaching said selected spreader head on to said rigid applicator pipe;
positioning said selected spreader head on joint to be sealed;
depressing said trigger on said control handle and trigger assembly to activate said battery to drive said motor causing said plunger to propel said sealant along said applicator tube and applicator pipe and onto said spreader head; and
guiding said selected spreader head along said joint to be sealed.

15. The method of claim 14, wherein the inserting sealant comprises installing a pre-filled tube of sealant.

16. The method of claim 14, wherein the inserting sealant comprises manually filling said cylindrical dispensing system with sealant.

17. The method of claim 14, wherein a rheostat is inserted in said circuit.

18. The method of claim 14, wherein said rheostat adjusted to modulate the dispensing of sealant.

19. A kit of parts to assemble the device of claim 1, the kit comprising:
a cylindrical dispensing system, comprising a plunger;
a flexible applicator tube configured to be attached to said cylindrical dispensing system;
a rigid applicator pipe configured to be attached to an other end of said applicator tube;
a spreader head configured to be attached to a dispensing end of said rigid applicator pipe;
an actuator operatively connected to said dispensing system;
a control handle and trigger configured to attach to said rigid applicator pipe; and
a circuit connecting a battery terminal with a motor, configured to drive said actuator along said cylindrical dispensing system.

20. The kit of parts of claim 19, additionally comprising a battery and optionally a charging unit.
